(19) United States
(12) Patent Application Publication
(10) Pub. No.: US 2023/0021932 A1
(43) Pub. Date: Jan. 26, 2023

(54) TRANSACTION PROCESSING APPARATUS, TRANSACTION PROCESSING SYSTEM AND METHOD

(71) Applicant: TOSHIBA TEC KABUSHIKI KAISHA, Tokyo (JP)

(72) Inventors: Kenya HIRAMATSU, Kita Tokyo (JP); Naotake HIRAMATSU, Kyoto Kyoto (JP); Yusuke YAMAGUCHI, Hiroshima Hiroshima (JP); Kento DOAMI, Hiroshima Hiroshima (JP)

(21) Appl. No.: 17/851,655

(22) Filed: Jun. 28, 2022

(30) Foreign Application Priority Data
Jul. 14, 2021 (JP) 2021-116257

(51) Int. Cl. G06Q 20/20; G06Q 20/12; G06Q 20/32; G06Q 20/06

(52) U.S. Cl. CPC G06Q 20/202; G06Q 20/127; G06Q 20/3274; G06Q 20/065

(57) ABSTRACT

A server system of an embodiment for transaction processing includes a virtual point-of-sale server to register data of a customer transaction based on data received from a first terminal operated by the customer in a selling area and a management server. The management server generates a machine-readable code including information for acquiring the transaction data and an electronic settlement method. The management server transmits the machine-readable code to the first terminal upon receiving a checkout instruction. Upon receiving information for acquiring the transaction data from a second terminal, the management server acquires the transaction data from the virtual point-of-sale server, and processes an electronic payment if the information regarding the electronic settlement method is received from the second terminal.

### CROSS-REFERENCE TO RELATED APPLICATION

This application is based upon and claims the benefit of priority from Japanese Patent Application No. 2021-116257, filed Jul. 14, 2021, the entire contents of which are incorporated herein by reference.

### FIELD

Embodiments described herein relate to a transaction processing apparatus, a transaction processing system, and a method for a server of a transaction processing system.

### BACKGROUND

There is a known type of transaction processing system in which customers may themselves register items of merchandise for purchase while moving about and shopping of a sales floor area or the like. In such systems, customer will operate a mobile terminal, such as a smartphone or a tablet terminal, to input the data about the items of merchandise to be purchased.

This type of transaction processing system can also sometimes include a dedicated type of self-service checkout device, machine, or kiosk to process customer payments for the items registered via the mobile terminal. Thus, a self-service customer and a regular (non-self-service) customer will use different types of checkout machines dedicated to each customer type. Usually, a dedicated self-service checkout machine for the self-service customers is not used (or may not be usable) to separately register items for purchase. Accordingly, the self-service customer generally has an advantage of a smoother checkout with less waiting in line as compared to a regular customer.

The self-service customer who has finished shopping sends a checkout request from the mobile terminal. In response to the checkout request, a barcode for checkout can be displayed on a display device of the mobile terminal. The customer then scans the barcode with a scanner provided at the dedicated self-service checkout machine. The barcode provides the information (or access to the information) about the registered items to be purchased according to the previous registration of items by the customer with the mobile terminal. For example, a list of registered items and information corresponding thereto is then loaded into the self-service checkout machine based on the barcode and a settlement amount (transaction amount due) for the registered items is calculated based on the list of registered items. The amount due is displayed on a display device of the self-service checkout machine, and the customer then pays the amount due at the machine. The payment at the machine may be made by cash, a credit card, electronic money, or the like.

However, a self-service customer must still make payment after the scanning operation of the barcode at the checkout machine, which still causes some delays to the self-service customer.

### BRIEF DESCRIPTION OF THE DRAWINGS

FIG. 1 is a block diagram showing a schematic configuration of a transaction processing system according to one embodiment.

FIG. 2 is a schematic diagram of a customer record stored in a customer database.

FIG. 3 is a schematic diagram of a gate device with checkout machine.

FIG. 4 is a block diagram showing an internal configuration of a gate device with checkout machine.

FIG. 5 is a sequence diagram used for explanation of operations before shopping by a customer.

FIG. 6 is a sequence diagram used for explanation of operations during shopping but before checkout.

FIG. 7 is a sequence diagram used for explanation of operations of a checkout at a dedicated checkout machine.

FIG. 8 is a sequence diagram used for explanation of operations of a checkout at a gate device with checkout machine.

FIG. 9 is a schematic diagram showing an example of an entry code reading window displayed on a smartphone.

FIG. 10 is a schematic diagram showing an example of a registering window.

FIG. 11 is a schematic diagram showing an example of a scanning window.

FIG. 12 is a schematic diagram showing an example of a registering window.

FIG. 13 is a schematic diagram showing an example of a checkout window.

FIG. 14 shows an example of a window displayed on a touch panel of a gate device with checkout machine when the remaining amount of electronic money is sufficient.

FIG. 15 shows an example of a window when a remaining amount of electronic money is insufficient.

### DETAILED DESCRIPTION

An embodiment provides an improved transaction processing system for retail stores and the like which addresses existing problems related to self-service customer delays experienced with the use of self-service checkout machines.

In general, according to one embodiment, a transaction processing server system includes a virtual point-of-sale server to register data of a customer transaction based on data received from a first terminal operated by the customer in a selling area and a management server. The management server generates a machine-readable code including information for acquiring the transaction data and an electronic settlement method. The management server transmits the machine-readable code to the first terminal upon receiving a checkout instruction. Upon receiving information for acquiring the transaction data from a second terminal, the management server acquires the transaction data from the virtual point-of-sale server, and processes an electronic payment if the information regarding the electronic settlement method is received from the second terminal.

In the following, certain example embodiments will be explained by reference to the drawings.

The described non-limiting examples concern a transaction processing system for a retail store at which a customer can register items for purchase using a mobile terminal while walking about the selling floor area of the store, then pay for such registered items upon exit of the selling floor area using a dedicated checkout machine for such self-registering (self-service) customer. The m mobile terminal used to register items to be purchased may be a smartphone or the like. In the following description, the customer may be referred to as a “consumer” or a “member”.

Configuration of Transaction Processing System

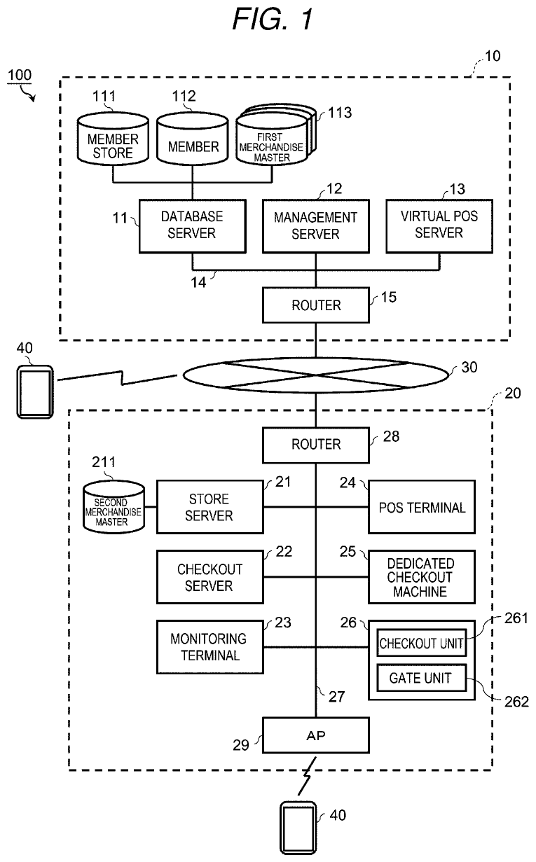

FIG. 1 is a block diagram showing a schematic configuration of a transaction processing system 100 according to an embodiment. The transaction processing system 100 includes a server system 10, which can be a cloud-based system in this example, and a point-of-sale (POS) system 20 that is in a particular member store. The server system 10 and the POS system 20 can make interactive data communications through a network 30 using an internet protocol. The network 30 can be a wide-area network using a public line or a dedicated line as a relay network and a wired LAN (Local Area Network), a wireless LAN, a mobile communication network, a cellular phone communication network, or the like as an access network. In the present example, a smartphone 40 using the cellular phone communication network can access the server system 10 via the network 30.

In the present context, a “member store” is a store signing a service contract with a management company of the server system 10. In FIG. 1, the POS system 20 of just one member store is shown, but there is no particular limit on the number of member stores (and corresponding POS systems) connected to the server system 10 via a network 30. The POS systems of the other member stores do not necessarily need to have the same configuration as the POS system 20 shown in FIG. 1. The details of configurations of the POS systems of other stores may vary depending on preferences of the member stores.

The server system 10 includes a database server 11, a management server 12, and a virtual POS server 13, which are connected by a communication line 14. A router 15 is connected to the communication line 14. The server system 10 is connected to the network 30 via the router 15.

The database server 11 manages a member store database 111, a member database 112, and merchandise masters 113 (e.g., a list of the items for sale (and corresponding information) at the respective member stores). In some examples, additional databases/information may be managed, tracked, or stored by the database server 11.

The member store database 111 is an aggregate of member store records for each member store registered to use the transaction processing system 100. A member store record is a data record associated with a unique store ID set for each member store. Each member store record includes various kinds of data about the particular member store. The member store record includes, for example, a network address necessary for data communications with the member store through the network 30.

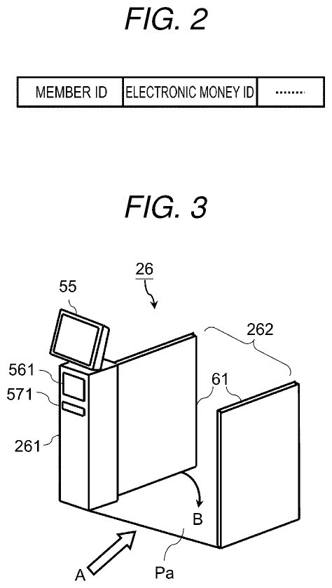

The member database 112 is an aggregate of member records for each consumer who has completed a member registration for using the transaction processing system 100 as a shopper. A member record is a data record associated with a unique member ID set for each consumer. Each member record includes various kinds of data about the registered consumer. As shown in FIG. 2, the member record includes an electronic money ID for a type of electronic money system used by the consumer. The electronic money ID is an example of data that can be used for an electronic settlement (electronic payment). In general, the electronic money ID is also unique to the consumer and particularly associated with the consumer in a server of an electronic money management company or the like.

The merchandise master 113 of each member store comprises merchandise records, which in aggregate form a list of the items for sale at the corresponding member store. Each merchandise record includes a unique merchandise code for the listed item of merchandise along with various other information about the item, such as a merchandise name, a unit price, etc. Each merchandise master 113 is uploaded from a corresponding member store to the database server 11 at a predetermined time, such as before the opening of the store each day.

In some examples, the merchandise master 113 may be managed by the virtual POS server 13 rather than database server 11. Likewise, in some examples, the member store database 111 and the member database 112 may be managed by the management server 12 rather than the database server 11. In some such examples, the database server 11 may be omitted as a distinct component.

The management server 12 operates with the database server 11 and the virtual POS server 13 to provide management of information about the transactions of customers shopping in a member store using the transaction processing system 100. The virtual POS server 13 provides a service of virtual registration of merchandise being purchased by customers at a member store using a point-of-sale application (a “POS app”) on a mobile terminal or the like.

The POS system 20 includes a store server 21, a checkout server 22, a monitoring terminal 23, a POS terminal 24, a dedicated checkout machine 25, and a gate device 26. These components are connected by an in-store network 27. A router 28 is connected to the in-store network 27, and the POS system 20 is connected to the network 30 via the router 28. An access point 29 is connected to the in-store network 27 and permits communication with smartphone 40.

The store server 21 manages such things as sales information of the member store, merchandise inventory information, and product ordering information based on the information about sales transactions settled at the member store.

The store server 21 includes a merchandise master 211. The merchandise master 211 comprises merchandise records, which in aggregate form a list of the items for sale at the member store. Each merchandise record includes a unique merchandise code for the listed item of merchandise along with various other information about the item, such as a merchandise name, a unit price, etc. In general, the merchandise master 113 stored in the server system 10 for member store is a copy of the merchandise master 211 managed by the store server 21. That is, a copy of merchandise master 211 is uploaded to the server system 10 to become the merchandise master 113. However, it should be noted regarding the merchandise master 211, when the price or the like of an item or items is changed during business hours (after upload), the change is initially reflected only in the data of the merchandise master 211. Therefore, such things as item prices may be different between the merchandise master 113 and the merchandise master 211 depending on recency of updates and uploads to the server system 10.

The store server 21 also provides a member monitoring function in conjunction with the monitoring terminal 23. The member monitoring function is a function of monitoring a current status of a customer shopping using the transaction processing system 100. By the member monitoring function, a list of merchandise to be purchased by the customer is generated based on the item data input by the customer using the smartphone 40 and then displayed on a monitor of the monitoring terminal 23. A warning may be displayed at the monitoring terminal 23 when certain predetermined events set to trigger a report to a staff member (store clerk) occur. The trigger may be related to, for example, registration/purchase of age-restricted products such alcohol, cigarettes, or the like. An attempted registration of a merchandise code by barcode scanning for which no corresponding merchandise record is present in the merchandise master 211 or other erroneous registration attempt may trigger a monitoring alert or notification.

The checkout server 22 provides support for the checkout of the customer using the dedicated checkout machine 25 or the gate device 26.

The POS terminal 24 is a checkout machine primarily for settlement of transactions of a customer not using the transaction processing system 100. For the POS terminal 24, a staff member serves as an operator. In some examples, the POS terminal 24 can also be used to settle a transaction with customers using the transaction processing system 100. In some examples, a POS terminal 24 may be separated into a registration machine at which a staff member registers items for purchase and a checkout machine at which the customer makes a payment for the registered items. Such an arrangement is referred to as a semi-self-service system. In other examples, a POS terminal 24 may be a full-self-service-type system at which the customer performs both the registration processing and the checkout processing by himself or herself.

The dedicated checkout machine 25 is a checkout machine permitting a settlement of a transaction with a customer using the transaction processing system 100. For the dedicated checkout machine 25, the customer serves as an operator. The dedicated checkout machine 25 is not available for settlement processing of a customer that is not using the transaction processing system 100.

The dedicated checkout machine 25 has a function of scanning a checkout barcode displayed on the smartphone 40 of the customer using the transaction processing system 100, a payment processing function for receiving payment(s) for the settlement amount by one of the various payment methods such as electronic money, a credit card, cash, or the like. The dedicated checkout machine 25 may also have a function permitting the re-charging of an electronic money account or the like by receipt of payments by another method.

The gate device 26 includes a checkout unit 261 and a gate unit 262. The checkout unit 261 can scan a two-dimensional code (checkout code) displayed on the smartphone 40 and also receive a payment (perform payment processing) to settle a transaction in electronic money or the like. The gate unit 262 can control the leaving of the store area (selling area) by the customer.

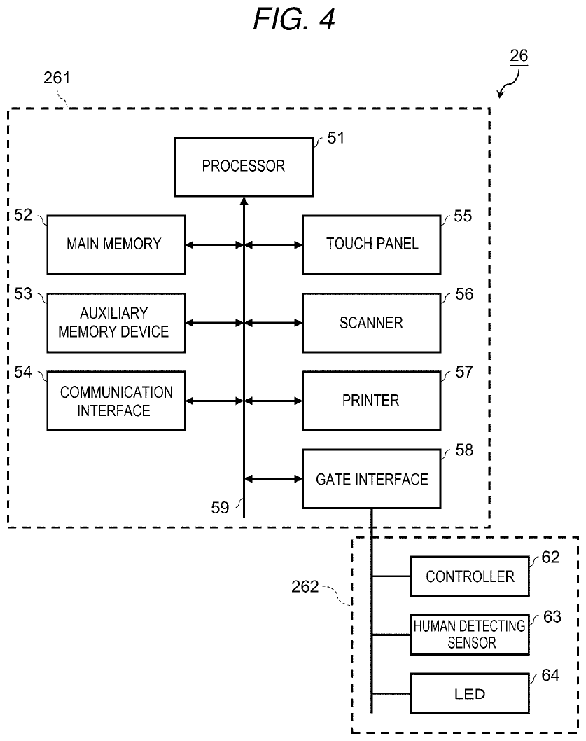

A schematic configuration of the gate device 26 will be explained using FIG. 3 and FIG. 4.

As shown in FIG. 3, the gate device 26 is provided in a pathway Pa for the customer to pass when leaving the selling area. In FIG. 3, the customer moves in the direction of an arrow A after settlement, passes through the pathway Pa, and thus leaves the selling area. The checkout unit 261 is installed at the selling area side of the pathway Pa. The checkout unit 261 includes a touch panel 55, a reading window 561 of a scanner 56, and a receipt dispenser opening 571. The touch panel 55, the reading window 561, and the receipt dispenser opening 571 are provided in positions for the customer to operate/access before entering the pathway Pa. The gate unit 262 includes a pair of gates 61 placed along the pathway Pa. In FIG. 3, at least one of the gates 61 moves in the direction of an arrow B by a drive mechanism to close the pathway Pa and thus block passage of the customer from the selling area. In the present embodiment, the gates 61 are normally closed and the pathway Pa is blocked until the gates 61 are opened (in the direction opposite to arrow B). The gates 61 are opened for a member only after settlement has been completed.

The possible arrangements of gates 61 are not limited to those shown in FIG. 3. In general, it is only necessary for the gates 61 to be able to appropriately block the pathway Pa in some manner to limit or control passage. Alternatively, instead of physically blocking the pathway Pa, the passage of the customer may be limited or controlled by the lighting of a lamp, the issuing of audio guidance, a sounding of an alarm, or the like.

As shown in FIG. 4, the checkout unit 261 includes a processor 51, a main memory 52, an auxiliary memory device 53, a communication interface 54, a touch panel 55, a scanner 56, a printer 57, a gate interface 58, and a system transmission channel 59. The system transmission channel 59 includes an address bus, a data bus, a control signal line, or the like.

In the checkout unit 261 the processor 51, the main memory 52, the auxiliary memory device 53, and the communication interface 54 are connected by the system transmission channel 59. The touch panel 55, the scanner 56, and the printer 57 may be external devices connected to the device interfaces of the checkout unit 261 or the like.

The processor 51 controls the various components of the checkout unit 261 for realization of various functions according to an operating system or an application program. The processor 51 is, for example, a CPU (Central Processing Unit).

The main memory 52 includes a non-volatile memory area and a volatile memory area. The main memory 52 stores an operating system or an application program in the non-volatile memory area. The main memory 52 may also store data necessary for controlling the various components in the non-volatile or volatile memory area. The volatile memory area can be a work area in which data can be written or rewritten by the processor 51 during operations. The non-volatile memory area is, for example, a ROM (Read Only Memory). The volatile memory area is, for example, a RAM (Radom Access Memory).

An EEPROM (Electric Erasable Programmable Read-Only Memory), an HDD (Hard Disc Drive), an SSD (Solid-State Drive), or the like may be used as the auxiliary memory device 53. The auxiliary memory device 53 stores data used by the processor in various processes, data created by processes of the processor 51, or the like. The auxiliary memory device 53 may store an application program.

The communication interface 54 connects to the in-store network 27. The checkout unit 261 communicates via the communication interface 54 with the store server 21, the checkout server 22, and other components connected to the in-store network 27.

The touch panel 55 is an input/output (I/O) device including a display screen for displaying of various images relating to a checkout and a touch sensor for detection of user touch operations on the images.

The scanner 56 is an input device for optically reading a machine-readable code such as a barcode, a two-dimensional code, or the like that is held in front of the reading window 561. The scanner 56 is an example of a reading unit reading a machine-readable code.

The printer 57 is an output device for printing data on receipt paper, cutting off the receipt paper, and then dispensing a printed purchase receipt or the like from the receipt dispenser opening 571.

The gate interface 58 is for transmitting and receiving data signals to and from a controller 62, a human detecting sensor 63, and a light emitting device 64 of the gate unit 262. The controller 62 controls the opening and closing of the gates 61. The human detecting sensor 63 is provided to detect the presence of a human standing on the front side of the checkout unit 261. The light emitting device 64 has a lamp for letting the customer know whether or not passage through the pathway Pa is being permitted. For example, the light emitting device 64 is lit in green when the passage is permitted and red when the passage is not permitted.

The checkout unit 261 is an example of a checkout machine including the reading unit.

Operation of Transaction Processing System

Next, operations of the transaction processing system 100 will be explained. The aspects of the operations associated with advance preparation, the period before shopping starts, the period during shopping, the period before checkout, and the checkout.

<Advance Preparation>

A consumer wishing to do some shopping in a member store using the transaction processing system 100 first installs a dedicated application program (hereinafter, referred to as the “shopping app”) on smartphone 40 and registers as a member via member registration operation. The member registration is performed on the management server 12 of the server system 10 via the network 30. The management server 12 issues a member ID unique to the consumer who is registering, and records the member ID in the member database 112. The management server 12 sends the member ID via the network 30 to the smartphone 40 of the now-registered consumer. The smartphone 40 stores the member ID in association with the shopping app.

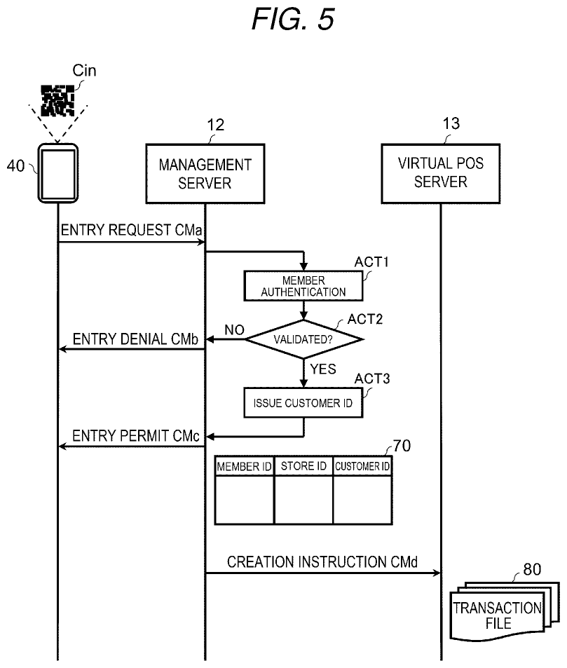

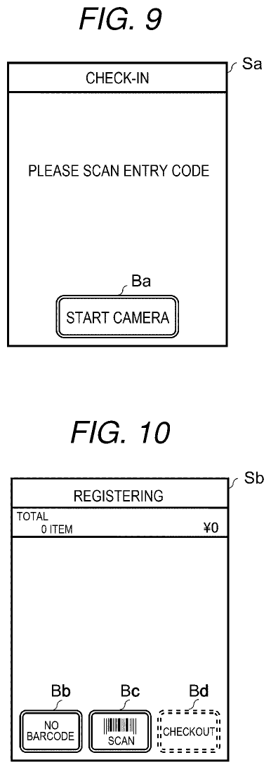

By the member registration, the consumer becomes a member. During the registration process, the member provide for or register the use of an electronic money system usable at the member store. If provided, the management server 12 records an electronic money ID in the member record for the member ID. of the use electronic money via the shopping app is option.

<Before Shopping (see FIGS. 5 and 9)>

The member starts the shopping app before entering the member store by operating the smartphone 40. When the shopping app is started, a window of a touch panel of the smartphone 40 changes to an entry code reading window Sa (FIG. 9). The entry code reading window Sa is for reading an entry code Cin (FIG. 5) using a camera provided in the smartphone 40.

The entry code Cin is offered at the entrance of the member store. For example, the entry code Cin is printed on a paper medium and stuck at the entrance. For example, the entry code Cin is displayed on a display placed at the entrance. The entry code Cin can be a two-dimensional code or the like corresponding to the member store and encoding setting information for the member store. The setting information includes, for example, a store ID for the member store and wireless LAN setting data. The wireless LAN setting data includes, for example, an SSID, a password, security setting information, and the like necessary for the smartphone 40 to connect to the access point 29 using a wireless LAN.

As shown in FIG. 9, a camera start button Ba is displayed in the entry code reading window Sa. The member touches the camera start button Ba to start the camera of the smartphone 40. The member then points the camera lens at the entry code Cin. The camera scans the entry code Cin.

After entry code Cin is scanned, the smartphone 40 transmits an entry request command CMa (FIG. 5) to the management server 12 via the network 30. The entry request command CMa includes the member ID corresponding to the smartphone 40 along with the store ID contained in the entry code Cin.

The management server 12 acquires the member ID via the entry request command CMa and performs member authentication (FIG. 5, ACT1). The member authentication checks whether or not the member ID is a valid member ID. For example, an invalid flag may be recorded in a member record of a consumer disqualified from membership because of resignation/withdrawal from membership, cheating, or the like. If the member ID is associated with an invalid flag, the management server 12 does not validate the member authentication in response to the entry request command CMa. If member ID is not associated with an invalid flag, the management server 12 validates the member authentication.

The management server 12 determines whether or not to validate the member authentication (FIG. 5, ACT2). If the member authentication is not passed/validated, the management server 12 returns an entry denial command CMb to the smartphone 40. The entry denial command CMb is transmitted to the smartphone 40 via the network 30. The smartphone 40 receiving the entry denial command CMb halts the shopping app. Therefore, the customer is unable to use the shopping app for self-service shopping at the store.

The management server 12 issues a customer ID if the member authentication is passed (FIG. 5, ACTS). The customer ID is a unique ID set each time the member does some shopping at a member store using the shopping app. For example, a unique customer ID is issued as a combination of a store code, a date, and an incrementing serial number for each shopper. The management server 12 associates the member ID and store ID acquired from the entry request command CMa with the issued customer ID and stores these IDs in a linkage table 70 (FIG. 5). That is, the linkage table 70 is a data table in which the member ID of the customer doing the self-service shopping is stored in association with the store ID of the member store at which the shopping is occurring and the unique customer ID issued for the transaction at the member store.

The management server 12 next returns an entry permit command CMc to the smartphone 40. The entry permit command CMc is transmitted to the smartphone 40 via the network 30. The smartphone 40 receiving the entry permit command CMc connects to the access point 29 via the wireless LAN using the wireless LAN data acquired as part of the entry code Cin. When the smartphone 40 is connected to the access point 29 via the wireless LAN, the window of the touch panel changes to a shopping start window. The shopping start window is a window prompting the consumer to start shopping. In the shopping start window, a shopping start button is displayed.

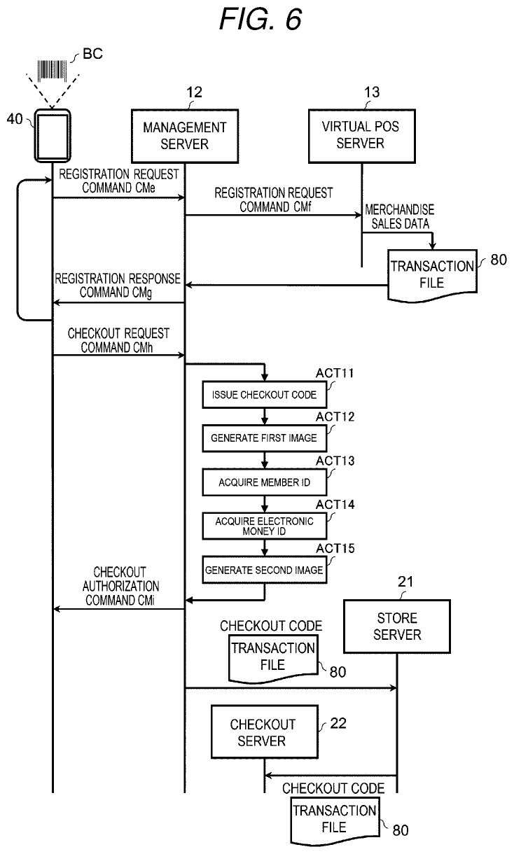

The management server 12 transmitting the entry permit command CMc also transmits a creation instruction command CMd to the virtual POS server 13 to create/start a transaction file on the virtual POS server 13. The creation instruction command CMd includes the store ID and customer ID stored in association with the member ID in the linkage table 70. The virtual POS server 13 receiving the creation instruction command CMd creates a transaction file 80 (FIG. 5) in a memory unit. The store ID and customer ID contained in the creation instruction command CMd are stored as part of the transaction file 80. The transaction file 80 is a data file in which sales data regarding the items of merchandise to be purchased by the member in the transaction (registered items) is stored in conjunction with the customer ID. Information about settlement payments received and the settlement amount due for the transaction can also be recorded in the transaction file.

<During Shopping (see FIGS. 6, 10, 11, and 12)>

To begin shopping, the member touches the shopping start button in the shopping start window. Then, the window changes to a registering window Sb (FIG. 10). As shown in FIG. 10, in the registering window Sb, a total number for presently registered items of merchandise and a total amount are displayed. In FIG. 10, no merchandise has been registered yet and thus both the total number and the total amount are “0”. In the registering window Sb, a no-barcode button Bb, a scan button Bc, and a checkout button Bd are displayed. The no-barcode button Bb is a button to be touched before inputting data (registering) of an item of merchandise with no barcode attached. The scan button Bc is a button to be touched before inputting data of merchandise with a barcode attached. The checkout button Bd is a button to be touched when the collection/registering of items is at an end and payment is to be made. Here, since no item of merchandise has been registered yet, and the checkout button Bd is inoperable. For example, the checkout button Bd is grayed out. In some examples, the checkout button Bd may not be displayed before the registering of at least one item.

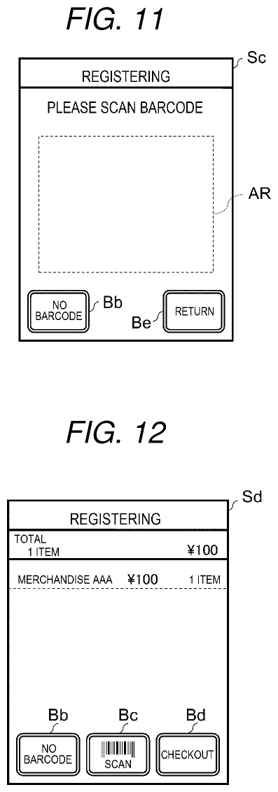

After finding merchandise to purchase in a selling area (sales floor), the member checks whether or not a barcode BC (FIG. 6) is attached to the merchandise to be purchased. When the barcode BC is attached, the member touches the scan button Bc. After the scan button Bc is touched, the window of the touch panel changes to a scanning window Sc (FIG. 11). As shown in FIG. 11, in the scanning window Sc, a frame line AR showing a reading area for a barcode is displayed. The no-barcode button Bb and a return button Be are also displayed at this time in this example. The return button Be is a button that can be touched for stopping the scanning attempt.

The member operates the smartphone 40 so that the barcode BC of the item to be purchased is located within the frame line AR. When the barcode BC is located within the frame line AR, the barcode BC can be scanned by the camera of the smartphone 40.

The smartphone 40 then transmits a registration request command CMe (FIG. 6) to the management server 12 via the wireless LAN. The registration request command CMe includes the member ID and the data encoded in the barcode BC, which is referred to as barcode data. The registration request command CMe is received at the access point 29 and further transmitted from the router 28 to the management server 12 via the network 30.

The management server 12 searches the linkage table 70 for the member ID contained in the registration request command CMe and acquires the store ID and customer ID associated with the member ID. Then, the management server 12 transmits a registration request command CMf with the member ID being replaced by the store ID and the customer ID from the linkage table 70 to the virtual POS server 13.

The virtual POS server 13 acquires the store ID, the customer ID, and the barcode data from the registration request command CMf. Then, the virtual POS server 13 extracts or obtains the merchandise code from the barcode data. The virtual POS server 13 searches the merchandise master 113 of the member store matching the store ID in registration request command CMf and acquires the merchandise record matching the merchandise code. Then, the virtual POS server 13 records merchandise sales data including the merchandise code, a merchandise name, a price, a number of merchandise to be sold, a sales amount, and the like in the transaction file 80. Here, the virtual POS server 13 functions as a registration unit.

The management server 12 receives the transaction file from the virtual POS server 13, then transmits a registration response command CMg (FIG. 6) to the smartphone 40. The registration response command CMg includes data of the transaction file 80 acquired from the virtual POS server 13. The registration response command CMg is transmitted from the router 15 to the POS system 20 via the network 30, and further transmitted from the access point 29 to the smartphone 40.

In the smartphone 40 receiving the registration response command CMg, the window of the touch panel changes to a registering window Sd (FIG. 12). The registering window Sd is a window shown when the merchandise sales data of first merchandise AAA is registered in the transaction file 80. As shown in FIG. 12, in the registering window Sd, the sales amount “Y100” and the number of merchandise to be sold “1 ITEM” of the merchandise AAA are displayed. Further, the total number is “1 ITEM” and the total amount is “Y100”. Furthermore, the checkout button Bd is now enabled.

Then, for the second and subsequent items of merchandise to be purchased, the member touches the scan button Bc and scans the barcode of the merchandise. The management server 12 and the virtual POS server 13 operate in the same manner for these subsequent items as described above for the first item. As a result, in the registering window Sb, a name of the merchandise to be purchased, the sales amount, the number of merchandise to be sold, the total number, and the total amount are displayed.

As described above, the sales amount of the merchandise sales data stored in the transaction file 80 is calculated based on the prices in the merchandise master 113. If a price is changed during business hours, the change might not be reflected in the merchandise master 113. Accordingly, the sales amount and the total amount displayed in the registering window Sd may be different from the amounts that would be displayed or calculated based on the actual prices at the present time (that is, the prices set in the merchandise master 211 of the store). Therefore, the sales amount and the total amount displayed in the registering window Sd are just to be considered as representative amounts (as opposed to actual amounts) during shopping using the shopping app.

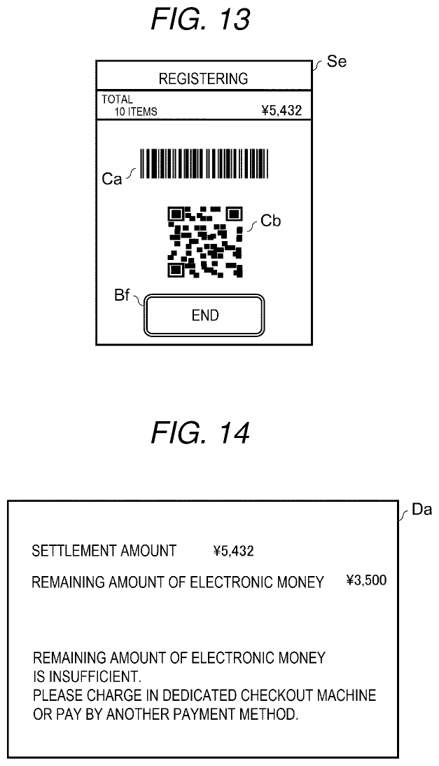

Note that, when no barcode is attached to the merchandise to be purchased, the member touches the no-barcode button Bb. A list of no-barcode merchandise is then displayed on the touch panel of the smartphone 40, and the member selects the merchandise to be purchased from the list. Then, the registration request command CMe containing the merchandise ID of the merchandise to be purchased is then transmitted to the management server 12. The subsequent operation is the same as that when the barcode BC of the merchandise is scanned with the smartphone 40.

<Before Checkout (see FIGS. 6 and 13)>

The member who finishes shopping in the selling area and moves to a checkout touches the checkout button Bd in the registering window Sd. When the checkout button Bd is touched, the smartphone 40 transmits a checkout request command CMh (FIG. 6) to the management server 12 via the wireless LAN. The checkout request command CMh includes the member ID. The checkout request command CMh is received at the access point 29 and transmitted from the router 28 to the management server 12 via the network 30.

The management server 12 issues a checkout code (FIG. 6, ACT11). The checkout code can be, for example, a combination of a date, a time, and a serial number, and typically the same checkout code will not be issued in the course of the same business day. The management server 12 generates a first image Ca (FIG. 13) (FIG. 6, ACT12). The first image Ca is an image formed by barcoding of the checkout code. That is, the first image Ca is an image of a barcode to be used for checkout.

The management server 12 acquires the member ID from the checkout request command CMh (FIG. 6, ACT13). Then, the management server 12 searches the member database 112 and acquires an electronic money ID from the member record matching the member ID (FIG. 6, ACT14). The management server 12 generates a second image Cb (FIG. 13) (FIG. 6, ACT15). The second image Cb is an image formed by two-dimensional coding of the member ID and the electronic money ID. That is, the second image Cb is an image of a two-dimensional code generated for checkout.

The management server 12 transmits a checkout authorization command CMi to the smartphone 40. The checkout authorization command CMi includes or otherwise provides the first image Ca and the second image Cb.

A member who does not register to use electronic money will not have an electronic money ID associated therewith. In this case, the management server 12 does not generate the second image Cb. The management server 12 transmits the checkout authorization command CMi just providing the first image Ca to the smartphone 40.

The checkout authorization command CMi is transmitted to the POS system 20 via the network 30 and transmitted from the access point 29 to the smartphone 40 via the wireless LAN. At the smartphone 40 receiving the checkout authorization command CMi, the window of the touch panel changes to a checkout window Se (FIG. 13). As shown in FIG. 13, in the checkout window Se, the first image Ca and the second image Cb are displayed. Furthermore, in the checkout window Se, an end button Bf is displayed. The end button Bf is a button to be touched when cancelling the checkout process. Here, the management server 12 functions as a generation unit and a display control unit. The two-dimensional code for checkout is an example of a machine-readable code.

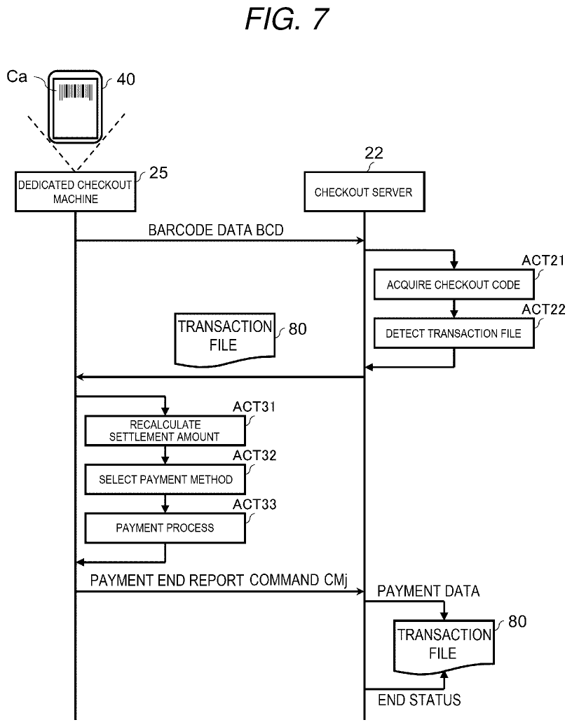

The management server 12 acquires the store ID and the customer ID stored in association with the member ID (from the checkout request command CMh) in the linkage table 70. Then, the management server 12 acquires the corresponding transaction file 80 from the virtual POS server 13. The management server 12 transmits the transaction file 80 and the checkout code to the POS system 20 of the member store matching the store ID. The data of the transaction file 80 and the checkout code is transmitted to the store server 21 of the corresponding member store via the network 30. The store server 21 transfers the data of the transaction file 80 and the checkout code received from the management server 12 to the checkout server 22. The checkout server 22 stores the transaction file 80 in association with the checkout code in memory.

<Checkout (see FIGS. 7, 8, 14, and 15)>

The member confirming the checkout window Se makes a checkout using the dedicated checkout machine 25 or the gate device 26. In general, the members making payment with electronic money would primarily use the gate device 26, which incorporates a checkout machine function. The members intending to make a payment with payment method other than electronic money would use the dedicated checkout machine 25, though it should be noted that in this example payment can also be made with electronic money at the dedicated checkout machine 25.

An operation of checkout using the dedicated checkout machine 25 is explained with reference to FIG. 7.

The member first scans the first image Ca (barcode for checkout displayed in the checkout window Se) with a scanner of the dedicated checkout machine 25. Then, data of the barcode for checkout, barcode data BCD (FIG. 7), is transmitted from the dedicated checkout machine 25 to the checkout server 22.

The checkout server 22 acquires the checkout code from the barcode data BCD (FIG. 7, ACT21). Then, the checkout server 22 finds the transaction file 80 associated with the checkout code in the memory (FIG. 7, ACT22). The checkout server 22 then transmits the transaction file 80 to the dedicated checkout machine 25.

The dedicated checkout machine 25 performs a recalculation of the settlement amount by reference to the merchandise master 211 managed by the store server 21. Specifically, the dedicated checkout machine 25 acquires the merchandise codes registered in the transaction file 80. Then, the dedicated checkout machine 25 searches the merchandise master 211 and acquires the presently listed prices corresponding to the merchandise codes. The dedicated checkout machine 25 multiplies the present price by the registered number of items to be sold in the transaction file 80 and calculates the sales amount by merchandise code. The dedicated checkout machine 25 executes this process on all of the merchandise codes registered in the transaction file 80. Then, the dedicated checkout machine 25 sums the sales amounts of all merchandise to be purchased and calculates the settlement amount.

The dedicated checkout machine 25 displays the recalculated settlement amount on a display. Then, the machine waits for selection of a payment method (FIG. 7, ACT32). As noted, the recalculated settlement amount may be different from the total amount previously displayed on the smartphone 40. But the amounts displayed on the smartphone 40 during shopping are to be considered only as representative amounts rather than actual amounts and the customer must settle the transaction and make a payment based on the actual amounts displayed on the dedicated checkout machine 25.

The member selects the desired payment method. For example, when cash is selected, the dedicated checkout machine 25 executes a payment process for paying the settlement amount by cash (FIG. 7, ACT33). For example, when a credit card is selected, the dedicated checkout machine 25 executes a payment process for paying the settlement amount by credit card. In general, these payment processes in this context are known processes and detailed explanation is omitted.

After finishing the payment process, the dedicated checkout machine 25 transmits a payment end report command CMj to the checkout server 22. The payment end report command CMj includes payment data. For example, for a payment by cash, the payment data includes a given amount, a change amount, and the like. For example, for a payment by a credit card, the payment data includes a payment amount by the credit card.

The checkout server 22 registers (stores) the payment data in the transaction file 80. Further, the checkout server sets an end status in the transaction file 80. The transaction file 80 with the end status set therein can be stored in the recording unit of the checkout server 22 or the store server 21.

The member who has finished checkout at the dedicated checkout machine 25 leaves the dedicated checkout machine and passes through the pathway Pa in which the gate device 26 is provided and leaves the selling area. The gates 61 may be closed initially and the member scans the barcode for checkout or the two-dimensional code for checkout displayed in the checkout window Se with the scanner 56 of the checkout unit 261. When the barcode for checkout or the two-dimensional code for checkout is scanned, data of the barcode for checkout or the two-dimensional code for checkout is transmitted from the checkout unit 261 to the checkout server 22.

The checkout server 22 checks whether or not the end status has been set for the transaction file 80 associated with the checkout code obtained from the barcode for checkout or the two-dimensional code for checkout. When the end status is set, the checkout server 22 transmits a gate open command CMk to the checkout unit 261. The checkout unit 261 controls the controller 62 to open the gates 61. Thereby, the member can leave the selling area through the pathway Pa.

On the other hand, when a member who did not perform a checkout at the dedicated checkout machine 25 scans the barcode for checkout with the scanner 56 of the checkout unit 261, the end status will not have been set for the transaction file 80 associated with the checkout code obtained from the barcode data, and the gate open command is not transmitted from the checkout server 22 to the checkout unit 261. Accordingly, the gates 61 are not opened. Therefore, the member not making a checkout is unable to leave the selling area through the pathway Pa.

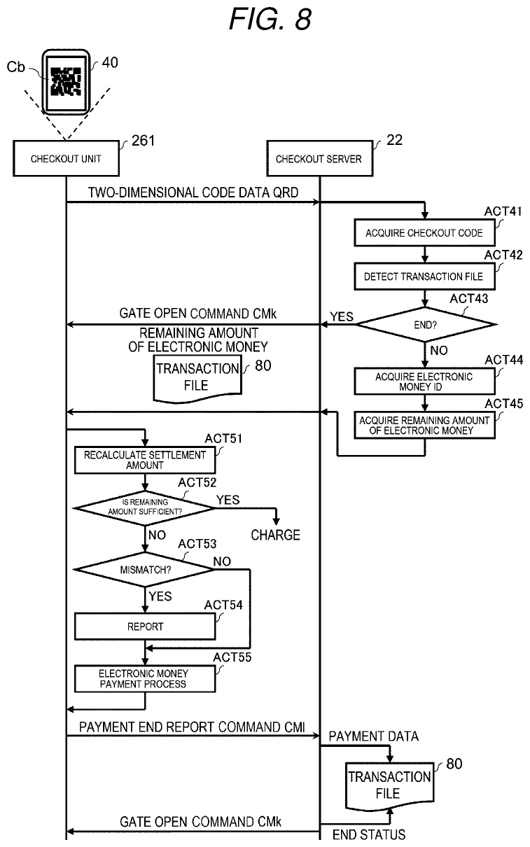

Next, using FIGS. 8, 14, and 15, an operation of checkout using the gate device 26 is explained.

The member holds the second image Cb, (the two-dimensional code for checkout) displayed in the checkout window Se over the reading window 561 of the checkout unit 261. Then, the two-dimensional code for checkout is scanned by the scanner 56 and the data of the two-dimensional code for checkout, two-dimensional code data QRD (FIG. 8) is transmitted from the checkout unit 261 to the checkout server 22.

The checkout server 22 acquires the checkout code from the two-dimensional code data QRD (FIG. 8, ACT41). Then, the checkout server 22 finds the transaction file 80 associated with the checkout code in memory (FIG. 8, ACT42).

Similarly, as with a checkout using the dedicated checkout machine 25, the checkout server 22 checks whether or not the end status is set for the transaction file 80 (FIG. 8, ACT43). When the end status has been set, the checkout server 22 transmits the gate open command CMk to the checkout unit 261.

When the end status is not yet set, the checkout server 22 acquires the electronic money ID from the two-dimensional code data QRD (FIG. 8, ACT44). Then, the checkout server 22 accesses the server of the appropriate electronic money management company via the network 30 and acquires the remaining amount of the electronic money managed in association with the electronic money ID (FIG. 8, ACT45). The checkout server 22 transmits the transaction file 80 and data indicating the remaining amount of the electronic money to the checkout unit 261.

The checkout unit 261 performs a recalculation of the settlement amount by reference to the merchandise master 211 like the dedicated checkout machine 25. Then, the checkout unit 261 checks whether or not the remaining amount of the electronic money is less than the settlement amount (FIG. 8, ACT52). When the remaining amount is less than the amount due (settlement amount), as shown in FIG. 14, the checkout unit 261 displays a window Da on the touch panel 55 prompting the charging of the electronic money (that is, adding money to the electronic money account or the like).

In the present example, the member is notified that the electronic money account can be charged at the dedicated checkout machine 25 by an instruction/message in the window Da. When charging of the electronic money account is finished, the member holds the two-dimensional code for checkout over the reading window 561 of the checkout unit 261 again. Or, alternatively, the member scans the barcode for checkout with the scanner of the dedicated checkout machine 25 and makes a checkout using a payment method other than the electronic money. It is also possible for the member to make a checkout by the electronic money payment at the dedicated checkout machine 25 after charging of the electronic money account at the dedicated checkout machine 25.

When the remaining amount of the electronic money is more than or equal to the amount due (settlement amount), the checkout unit 261 checks whether or not the actual settlement amount is the same as the reference amount (FIG. 8, ACT53). In this context, the reference amount is the transaction total amount calculated using the prices in the merchandise master 113 (managed by the server system 10) and might not be the same as the actual settlement amount (transaction total amount calculated using the prices in the merchandise master 211 managed by the POS system 20).

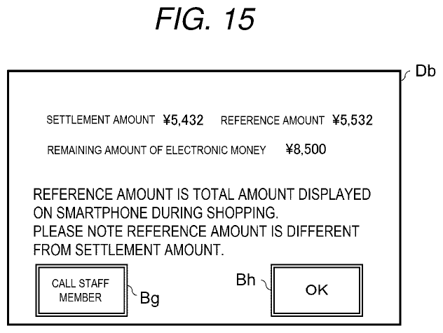

When the actual settlement amount is not the same as the reference amount, as shown in FIG. 15, the checkout unit 261 displays a window Db reporting the mismatch between the amounts on the touch panel 55 (FIG. 8, ACT54). In the window Db, the settlement amount, the reference amount, the remaining amount of the electronic money, and a message for report are displayed. Furthermore, a staff member call button Bg and an OK button Bh are displayed. The staff member call button Bg can be touched when wishing to confirm that the settlement amount is different from the reference amount with the staff member. The OK button Bh is a button touched when agreeing with the payment of the actual settlement amount.

When the staff member call button Bg is touched, the checkout unit 261 transmits a call signal to the monitoring terminal 23. Thereby, at the monitoring terminal 23, the staff member call is announced, and an attendant (an operator of the monitoring terminal 23) goes to the pathway Pa and talks with the customer.

When the OK button Bh is touched or when the settlement amount is the same as the reference amount, the checkout unit 261 executes a payment process by electronic money (FIG. 8, ACT55). That is, the checkout unit 261 executes a process of subtracting the settlement amount from the remaining amount of the electronic money. Further, the checkout unit 261 executes a process of printing a purchase receipt by driving the printer 57. The purchase receipt is dispensed from the receipt dispenser opening 571 and the member receives the receipt.

After the member receives the receipt, the checkout unit 261 transmits a payment end report command CM1 to the checkout server 22. The payment end report command CM1 includes payment data indicating the electronic money payment.

The checkout server 22 registers the payment data in the transaction file 80. The checkout server 22 also sets the end status in the transaction file 80. The transaction file 80 can then be stored in the recording unit of the checkout server 22 or the store server 21 as a transaction record.

After successful payment processing (or a determination that the transaction is ended), checkout server 22 transmits a gate open command CMk to the checkout unit 261. The checkout unit 261 controls the controller 62 to open the gates 61. Thereby, the member can leave the selling area through the pathway Pa. Note that the time to output the gate open command CMk may be before or after the setting of the end status in the transaction file 80. Here, the checkout server 22 cooperatively operates with the gate device 26 and functions as a processing unit and a permission unit.

The description of the operation of the transaction processing system is otherwise as described above.

The virtual POS server 13 of the transaction processing system 100 functions as a registration unit. The management server 12 functions as a generation unit and a display control unit. The checkout server 22 cooperatively operates with the gate device 26 and functions as a processing unit and a permission unit. Furthermore, the gate device 26 functions as a checkout machine including a reading unit (scanner 56) for reading a machine-readable code (two-dimensional code for checkout). Therefore, the virtual POS server 13, the management server 12, and the checkout server 22 may each be referred to as a server of the transaction processing system 100. The server(s) may be referred to as a transaction processing apparatus.

Effects of Transaction Processing System

According to an embodiment, the member registering to use electronic money at the member store can make a checkout by using the gate device 26. It is only necessary in such a checkout process for the member to hold the second image Cb (the two-dimensional code for checkout) displayed on the smartphone 40 over the reading window 561. It is not necessary for electronic money payments to perform a plurality of steps including scanning the first image Ca (barcode for checkout), selecting a payment method via a payment selection window, and then providing an electronic money ID to the checkout machine as is the case in related art. Therefore, the checkout process can be made quick and efficient.

The gate device 26 is provided on/at the pathway Pa. Thus, the customer finishing a checkout at the gate device 26 can leave the selling area through the pathway Pa. Therefore, leaving the selling area becomes smoother. As a result, congestion at the checkout area can be reduced and more customers can be handled in a shorter time.

The management server 12 generates a first code (a checkout code corresponding to data of the sales transaction) and a second code (machine-readable code also containing the electronic money ID for an electronic settlement of the transaction). Therefore, the checkout server 22 can acquire not only the checkout code but also the electronic money ID for checkout at the same time from the machine-readable code (two-dimensional code), and the overall processing time can be shortened.

The smartphone 40 used by the member is not only used for input of data about the merchandise to be purchased but also functions as a display medium for the second image Cb (the two-dimensional code for checkout). Therefore, the member can perform the series of operations from the merchandise registration through the final settlement using the smartphone 40 as a self-service shopping terminal.

When there is a difference between the total amount displayed (reference amount) on the smartphone during shopping and the real final settlement amount, the window Db for reporting the mismatch between the amounts is displayed on the touch panel 55 of the gate device 26 to prompt the member to confirm the difference is acceptable. Therefore, troubles due to the mismatch between the amounts can be prevented in advance rather than after final settlement.

An example embodiment of the transaction processing system 100 is explained, however, the present disclosure is not limited to the example described above.

In the above described example, the terminal operated by the customer in the selling area while shopping and the terminal used by the customer for settlement purposes can be the same terminal (e.g., smartphone 40). However, in other examples, the terminal used for shopping (item registration) may be a tablet terminal attached to a shopping cart and the terminal used for settlement purposes may be a smartphone or the terminal used for shopping may be provided to the customer by the store but the terminal used for settlement purposes may be the customer's own personal smartphone.

In an example embodiment, a machine-readable code containing the electronic money ID and the checkout code is generated. But in other examples, the machine-readable code does not necessarily need contain the electronic money ID itself. The electronic money ID can be stored in association with the member ID in the member database 112. Accordingly, the machine-readable code may include the member ID and the checkout code. The checkout server 22 thus makes an inquiry to the server system 10 about the electronic money ID associated with the member ID. Then, the checkout server 22 may acquire the electronic money ID from the server system 10 and execute the process at ACT45 in FIG. 8 and subsequent processes.

In an example embodiment, the checkout server 22 checks the remaining amount of the electronic money and transmits the transaction file 80 with the remaining amount data to the checkout unit 261. In other examples, the checkout server 22 may transmit the transaction file 80 with the electronic money ID to the checkout unit 261, and the checkout unit 261 may itself check the remaining amount of the electronic money and execute the payment process by the electronic money accordingly.

In an embodiment, the electronic money is used for electronic settlement. However, methods of providing electronic settlement is not limited to the use of electronic money. For example, if credit card information can be provided as part of the machine-readable code, the electronic settlement method may be a payment by credit card (a credit card transaction). Or, if such information as rewards point data or vouchers can be used for payment the necessary information (rewards point account data or voucher information) be provided as part of the machine-readable code, the electronic settlement may be made with payment by such methods.

In an embodiment, the server system 10 is configured using cloud computing. In other examples, the POS system 20 may function as the server system 10. That is, the transaction processing system 100 can be configured in a single store.

In an embodiment, the server system 10 includes the database server 11, the management server 12, and the virtual POS server 13. In other examples, the server system 10 may be configured as a single server formed by an aggregation of the functions of the database server 11, the management server 12, and the virtual POS server 13.

Similarly, in the POS system 20 of each store, the functions may or may not be divided between the store server 21 and the checkout server 22. For example, the functions of the store server 21 and the checkout server 22 may be aggregated in a single server.

While certain embodiments have been described, these embodiments are presented as examples, but not intended to limit the scope of the invention. These novel embodiments may be implemented in other various forms and various omissions, replacements, changes may be made without departing from the scope of the invention. These embodiments or their modifications are within the scope of the invention and within the scope of the invention described in claims and equivalents thereof.

What is claimed is:

1. A transaction processing server system, comprising:
a communication interface;
a virtual point-of-sale server configured to register data of a transaction with a customer based on data received, via the communication interface, from a first terminal operated by the customer in a selling area; and
a management server configured to:
generate a machine-readable code including information for acquiring the data of the transaction and information regarding an electronic settlement method of the customer,
transmit the machine-readable code to the first terminal, via the communication interface, upon receiving a checkout instruction from the first terminal,
upon receiving the information for acquiring the data of the transaction from a second terminal which reads the machine-readable code from the first terminal, acquire the data of the transaction from the virtual point-of-sale server, and
process an electronic payment for settling the transaction if the information regarding the electronic settlement method is received, via the communication interface, from the second terminal.

2. The transaction processing server system according to claim 1, wherein the management server is further configured to transmit, via the communication interface, exit permission to the second terminal after processing the electronic payment.

3. The transaction processing server system according to claim 1, wherein the machine-readable code is a two-dimensional code incorporating first encoded information corresponding to the information for acquiring the data of the transaction and second encoded information corresponding to the information regarding the electronic settlement method of the customer.

4. The transaction processing server system according to claim 1, wherein the first terminal and the second terminal are the same terminal.

5. The transaction processing server system according to claim 1, wherein the machine-readable code includes a bar code and a QR-code.

6. The transaction processing server system according to claim 1, further comprising:
a database server configured to store a list of member stores registered to use the transaction processing server system, a list of member IDs of customers registered to use the transaction processing server system, and a merchandise master table for each member store listing product information about items sold at the member store.

7. The transaction processing server system according to claim 6, wherein at least one member ID is associated with an electronic money ID permitting the customer with the corresponding member ID to make a settlement of the transaction with electronic money.

8. The transaction processing server system according to claim 1, wherein the management server and the virtual point-of-sale server are cloud-based virtualized servers.

9. A sales transaction processing system, comprising:
a point-of-sale terminal at a store location permitting customers to register items for purchase and make payments for the registered items;
a dedicated checkout machine at the store location permitting customers to make payments for items registered for purchase via a mobile terminal operating a shopping app;
a gate device at an exit of the store location, the gate device including a gate unit that opens and closes the exit and gate checkout machine configured to process an electronic settlement of a customer using the mobile terminal; and
a transaction processing server system including:
a communication interface;
a virtual point-of-sale server configured to register data of a transaction with the customer based on data received, via the communication interface, from the mobile terminal operated by the customer at the store location; and
a management server configured to:
generate a machine-readable code including information for acquiring the data of the transaction and information regarding an electronic settlement method of the customer,
transmit the machine-readable code to the mobile terminal, via the communication interface, upon receiving a checkout instruction from the mobile terminal,
upon receiving the information for acquiring the data of the transaction from one of the point-of-sale terminal, the dedicated checkout machine, or the gate device which has read the machine-readable code from the mobile terminal, acquire the data of the transaction from the virtual point-of-sale server, and
process an electronic payment for settling the transaction if the information regarding the electronic settlement method is received, via the communication interface, from one of the point-of-sale terminal, the dedicated checkout machine, or the gate device which has read the machine readable code.

10. The sales transaction processing system according to claim 9, wherein the management server is further configured to transmit, via the communication interface, exit permission to the gate device after processing the electronic payment.

11. The sales transaction processing system according to claim 9, wherein the machine-readable code is a two-dimensional code incorporating first encoded information corresponding to the information for acquiring the data of the transaction and second encoded information corresponding to the information regarding the electronic settlement method of the customer.

12. The sales transaction processing system according to claim 9, wherein the dedicated checkout machine and the point-of-sale terminal are configured to set a transaction complete flag in a transaction file stored by the management server upon receiving payment from the customer.

13. The sales transaction processing system according to claim 9, wherein the machine-readable code includes a bar code and a QR-code.

14. The sales transaction processing system according to claim 9, further comprising:
a database server configured to store a list of member stores registered to use the transaction processing server system, a list of member IDs of customers registered to use the transaction processing server system, and a merchandise master table for each member store listing product information about items sold at the member store.

15. The sales transaction processing system according to claim 14, wherein at least one member ID is associated with an electronic money ID permitting the customer with the corresponding member ID to make a settlement of the transaction with electronic money.

16. The sales transaction processing system according to claim 9, wherein the management server and the virtual point-of-sale server are cloud-based virtualized servers.

17. A transaction processing method, comprising:
registering, in a virtual point-of-sale server, data of a transaction with a customer based on data received, via a communication interface, from a first terminal operated by the customer in a selling area;
generating a machine-readable code including information for acquiring the data of the transaction and information regarding an electronic settlement method of the customer;
transmitting the machine-readable code to the first terminal, via the communication interface, upon receiving a checkout instruction from the first terminal;
upon receiving the information for acquiring the data of the transaction from a second terminal which reads the machine-readable code from the first terminal, acquiring the data of the transaction from the virtual point-of-sale server; and
processing an electronic payment for settling the transaction if the information regarding the electronic settlement method is received, via the communication interface, from the second terminal.

18. The method according to claim 17, wherein the machine-readable code includes a bar code and a QR-code.

19. The method according to claim 17, further comprising:
transmitting, via the communication interface, exit permission to the second terminal after processing the electronic payment.

20. The method according to claim 17, wherein the machine-readable code is a two-dimensional code incorporating first encoded information corresponding to the information for acquiring the data of the transaction and second encoded information corresponding to the information regarding the electronic settlement method of the customer.
